(19) United States
(12) Patent Application Publication
(10) Pub. No.: US 2009/0141305 A1
(43) Pub. Date: Jun. 4, 2009

(54) Data processing apparatus

(75) Inventors: Kazuo INUI, Itami-Shi (JP); Hiroyuki IDEYAMA, Itami-shi (JP); Tomonari YOSHIMURA, Kyoto-Shi (JP)

Correspondence Address: BUCHANAN, INGERSOLL & ROONEY PC, POST OFFICE BOX 1404, ALEXANDRIA, VA, 22313-1404, US

(73) Assignee: Minolta Co. Ltd., Osaka (JP)

(21) Appl. No.: 12/320,175

(22) Filed: Jan. 21, 2009

Related U.S. Application Data
(62) Division of application No. 10/368,463, filed on Feb. 20, 2003.

(30) Foreign Application Priority Data
Feb. 20, 2002 (JP) 2002-42992

(51) Int. Cl. G06F 3/12

(52) U.S. Cl. 358/1.15

(57) ABSTRACT

A data processing apparatus has a first controller which specifies an output mode for image data to be processed and a second controller which determines whether the image data is stored in a memory or not based on the output mode specified by the first controller.

This application is based on Japanese Patent Application No. 2002-42992 filed in Japan on Feb. 20, 2002, the entire content of which is hereby incorporated by reference.

### BACKGROUND OF THE INVENTION

1. FIELD OF THE INVENTION

The present invention relates to a data processing apparatus capable of saving processed image data.

2. DESCRIPTION OF THE RELATED ART

In addition to the functions of a conventional facsimile apparatus that only sends and receives data regarding paper originals, the functions of facsimile transmission and receipt based on electronic data are also implemented in the prior art. Where only paper originals only are used, sent original documents can be managed relatively easily by filing the sent originals. However, where both paper originals and electronic data are used for data transmission, management of originals is quite complex. For example, where all originals are to be managed in paper form, electronic data sent must be printed out to paper for filing, and where all originals are to be saved as electronic data, paper originals must be converted into electronic data using a scanner for storage.

At the same time, multi-functional peripherals (MFPs) having the multiple functions of a copy machine, scanner and facsimile are widely marketed. An MFP device that stores as electronic data all images read via its copy machine, scanner or facsimile function has also been proposed. However, where all images read by the MFP are stored as electronic data, images that do not need to be stored are also stored, which gives rise to the problems that searching from among the stored images becomes more difficult and the amount of stored data becomes enormous.

### OBJECT AND SUMMARY

An object of the present invention is to provide an improved data processing apparatus that resolves the above problems.

Another object of the present invention is to provide a data processing apparatus that is capable of storing only the image data that needs to be saved.

These objects are attained by a data processing apparatus comprising, a first controller which specifies an output mode for image data to be processed; and a second controller which determines whether the image data is stored in a memory or not based on the output mode specified by the first controller.

### BRIEF DESCRIPTION OF THE DRAWINGS

These and other objects and features of the present invention will become clear from the following description taken in conjunction with the preferred embodiments thereof with reference to the accompanying drawings, in which:

FIG. 1 is a drawing showing the overall construction of a system including a data processing apparatus pertaining to one embodiment of the present invention;

FIG. 2 is a block diagram showing the circuit construction of an MFP;

FIG. 3 is a block diagram showing the circuit construction of a user personal computer;

FIG. 4 is a block diagram showing the circuit construction of a file server;

FIG. 5 is a flow chart showing a routine performed by an MFP;

FIG. 6 is a flow chart showing the routine executed during the image input operation (S23) shown in FIG. 5;

FIG. 7 is a flow chart showing the routine executed during the output mode analysis operation (S30) shown in FIG. 6;

FIG. 8 is a flow chart of the operations subsequent to those shown in FIG. 7;

FIG. 9 is a flow chart showing the routine executed during the transmission recipient determination operation (S518) shown in FIG. 8;

FIG. 10 is a drawing showing the routine executed during the file format determination operation (S63) shown in FIG. 9;

FIG. 11 is a drawing showing a user selection screen displayed during the file format determination operation (S63) shown in FIG. 9;

FIG. 12 is a flow chart showing the routine executed during the image output operation (S24) shown in FIG. 5; and

FIG. 13 is a drawing showing a transmission history display screen.

### DETAILED DESCRIPTION OF THE PREFERRED EMBODIMENTS

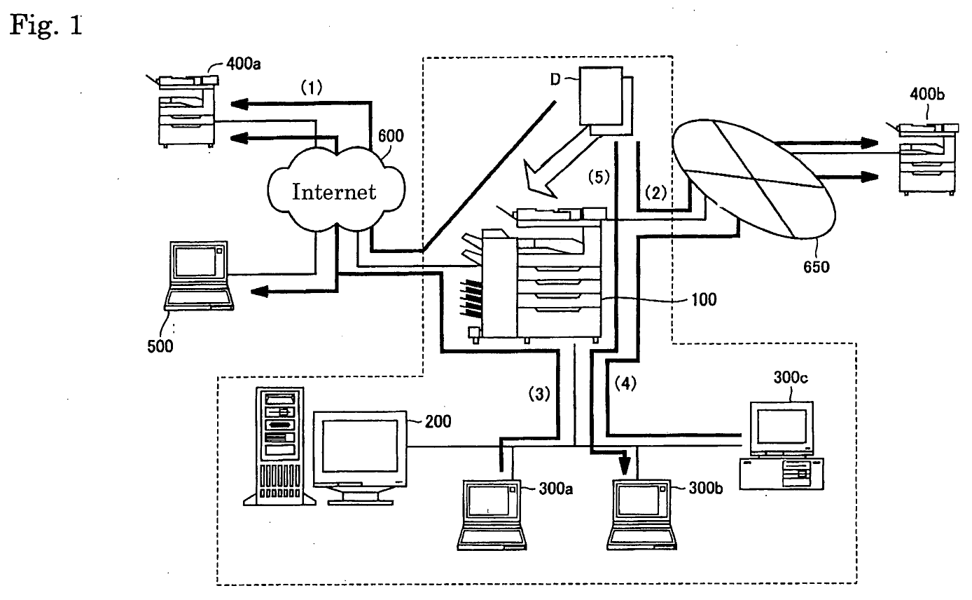

FIG. 1 is a drawing showing the overall construction of a system including a data processing apparatus pertaining to one embodiment of the present invention. With reference to the drawing, this system includes an MFP 100 that is connected to a LAN (Local Area Network), a file server 200 on which image data is stored, and user personal computers 300a-300c. The MFP 100 can send and receive data to and from an Internet facsimile 400a and a recipient personal computer 500 over the Internet 600. Furthermore, the MFP 100 can send and receive data to a facsimile apparatus 400b over an ordinary public telephone line 650. In this system, the MFP 100 comprises the data processing apparatus.

The MFP 100 has a scanner and a print engine, and can print via the print engine image data obtained by reading an original document D via the scanner and send the read image data to an external apparatus. It can also receive original document data in the form of electronic data and print it out via the print engine or forward it to an external apparatus.

With reference to FIG. 1, (1) shows the data path used when the original document D is read by the MFP and the image thereof is output via the Internet 600 by the facsimile apparatus 400a located separately from the MFP. The function by which to send or receive original document image data over the Internet 600 to or from an MFP or facsimile apparatus in this fashion is called the Internet facsimile function. (2) in the figure shows the data path used when the original document D is read by the MFP 100 and the image thereof is output via the ordinary public telephone line 650 by the facsimile apparatus 400b located separately from the MFP. The function by which to send or receive original document image data over the ordinary public telephone line to or from an MFP or facsimile apparatus in this fashion is called the regular facsimile function.

(3) shows the data path used when image data is sent over the Internet 600 from the user personal computer 300a connected to the LAN while using the MFP 100 as a gateway. The function by which to send or receive image data from a user personal computer to an MFP or facsimile apparatus or vice versa over the MFP 100 and the Internet 600 in this fashion is called the PC Internet facsimile function (or Internet printing function). (4) shows the data path used when image data is sent from the user personal computer 300c connected to the LAN to the external facsimile apparatus 400b over the ordinary public telephone line 650 while using the MFP 100 as a gateway. The function by which to send or receive image data from a user personal computer to an MFP or a facsimile apparatus or vice versa via the MFP 100 and the ordinary public telephone line 650 in this fashion is called the PC facsimile function.

(5) shows the data path used when the original document D is read by the MFP 100 and the image thereof is incorporated into the user personal computer 300b over the LAN.

The MFP has a printing function which is executed by its print engine, as described above, and is capable of both printing image data based on a print command received from within the LAN, rather than forwarding the image data, and printing as is an original document that has been read (regular copying).

The transmission and receipt of image data within the LAN may be achieved using a general protocol such as FTP or MTP, or using a local protocol used between the MFP 100 and the driver of the personal computer.

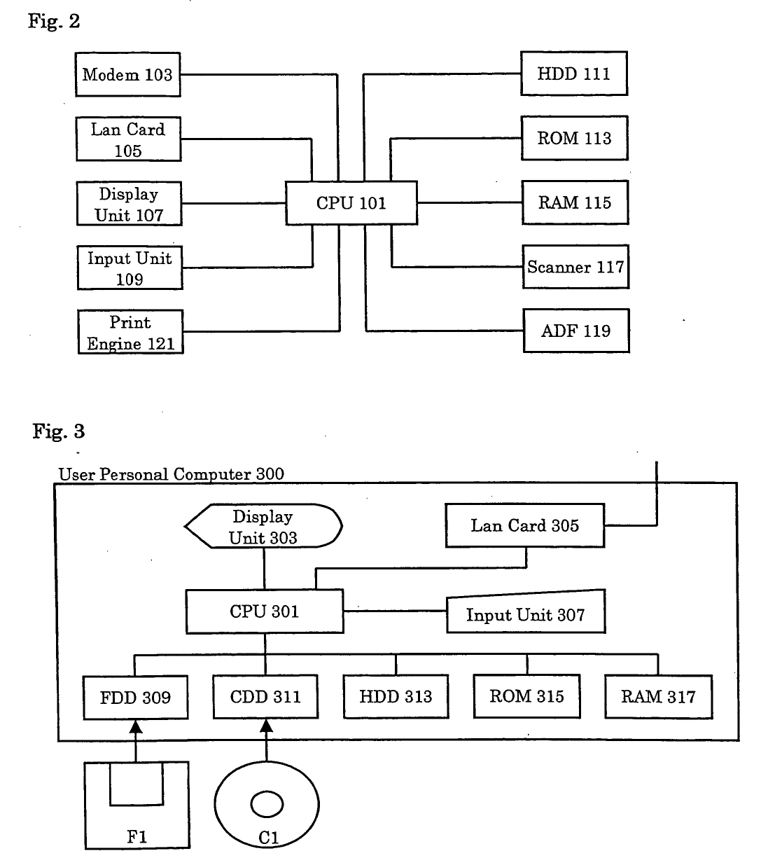

FIG. 2 is a block diagram showing the hardware construction of the MFP 100 shown in FIG. 1. With reference to the drawing, the MFP 100 includes a CPU 101 that performs overall control of the apparatus, a modem 103 by which to connect to the ordinary public telephone line 650, a LAN card 105 by which to connect to the Internet 600 or the LAN, a display unit 107 that displays information needed by the user, an input unit 109 comprising keys and the like by which to input information necessary in order for the user to operate the apparatus, a hard disk drive 111 that stores image data and the like, a ROM 113 that stores programs and the like, a RAM 115 that temporarily stores data, a scanner 117 by which to read original documents, an ADF or automatic document feeder 119, and a print engine 121 that prints image data.

FIG. 3 is a block diagram showing the hardware construction of one of the user personal computers.

With reference to the drawing, the user personal computer includes a CPU 301 that performs overall control of the apparatus, a display unit 303, a LAN card 305 by which to connect to the LAN, an input unit 307 comprising a keyboard and mouse or the like, a flexible disk drive 309, a CD-ROM drive 311, a hard disk drive 313, a ROM 315 and a RAM 317.

Image data and programs recorded on a flexible disk (F1) can be read by the flexible disk drive 309, and image data and programs recorded on a CD-ROM (C1) can be read by the CD-ROM drive 311.

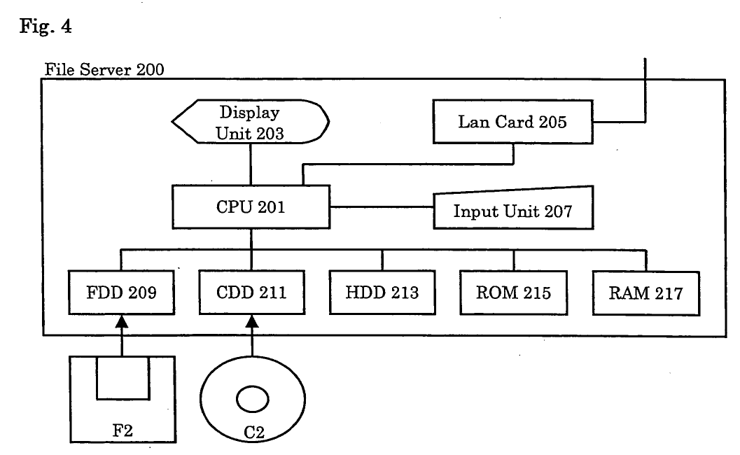

FIG. 4 is a block diagram showing the construction of the file server 200 shown in FIG. 1.

With reference to the drawing, the file server 200 includes a CPU 201 that performs overall control of the apparatus, a display unit 203, an input unit 205 comprising a keyboard and mouse or the like, a LAN card 207 by which to connect to the LAN, a flexible disk drive 209, a CD-ROM drive 211, a hard disk drive 213, a ROM 215 and a RAM 217.

As with the user personal computer shown in FIG. 3, image data and programs recorded on a flexible disk (F2) can be read by the flexible disk drive 209, and image data and programs recorded on a CD-ROM (C2) can be read by the CD-ROM drive 211.

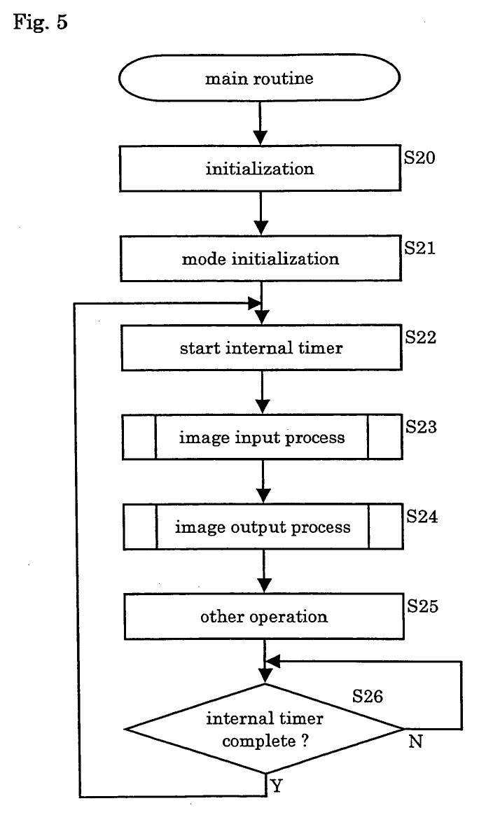

FIG. 5 is a flow chart showing the operations of the MFP 100.

With reference to the drawing, initialization is carried out in step S20, and mode initialization takes place in step S21. The internal timer is begun in step S22.

An image is input to the MFP 100 in step S23. The input image is output in step S24. Other operations are performed in step S25, and the CPU 101 stands by until the internal timer completes its counting cycle in step S26, whereupon it returns to step S22 when the counting cycle is completed.

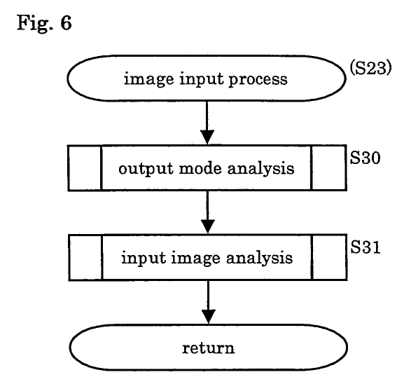

FIG. 6 is a flow chart showing the routine executed during the image input operation of step S23 shown in FIG. 5.

With reference to the drawing, output mode analysis is performed in step S30. This output mode analysis is an operation in which the output mode for the input image data is analyzed in order to determine the format of the image to be output.

Input image analysis is then carried out in step S31. This input image analysis is an operation in which the input image data is analyzed.

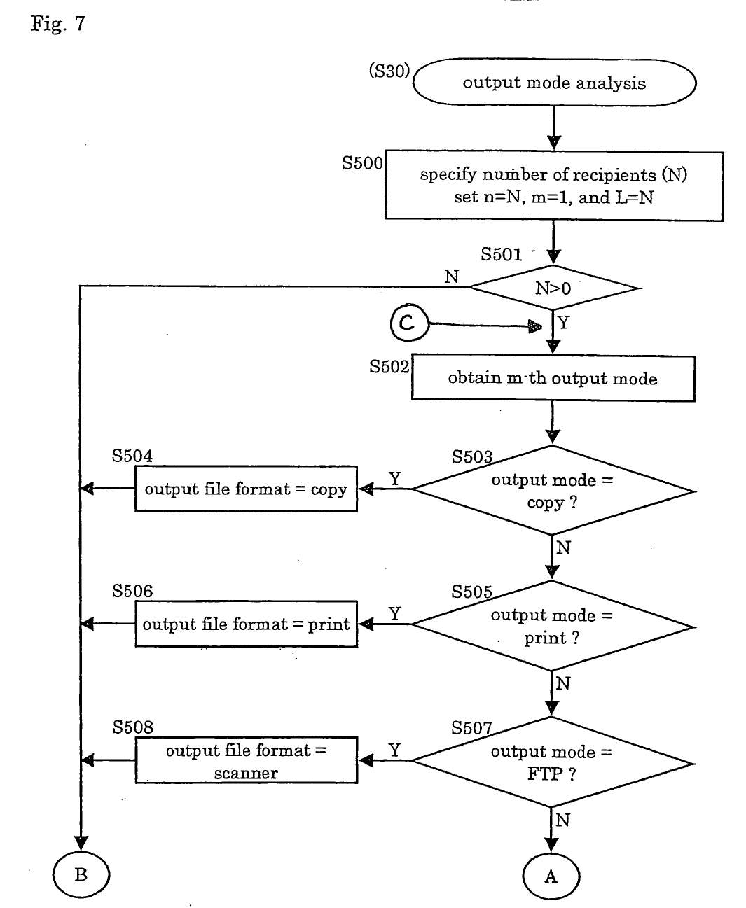

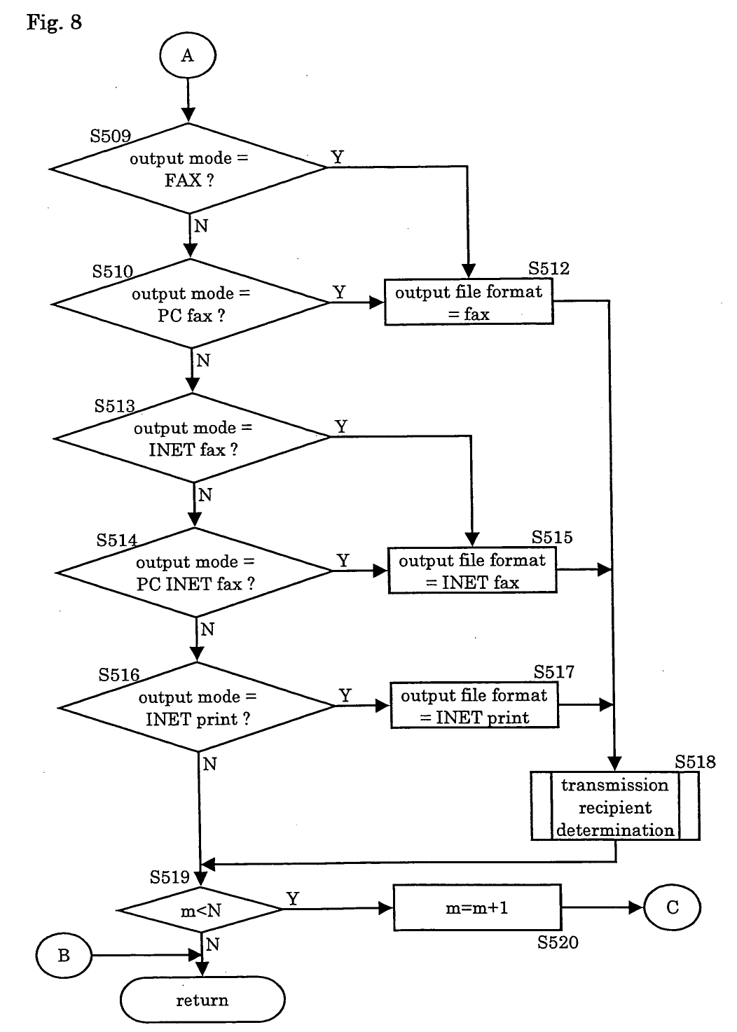

FIGS. 7 and 8 are flow charts showing the routine executed during the output mode analysis operation (step S30) shown in FIG. 6.

With reference to the drawing, the number N of recipients specified in connection with the image data is obtained in step S500. The number N is then substituted for the number (n) of transmission jobs. ‘1’ is substituted as an initial value for the number (m) of jobs as to which a determination has been made. N is also substituted for the variable L (number of output commands).

It is determined in step S501 whether the condition N>0 is met, and if this determination is negative, the CPU 101 returns to the main routine, while if the determination is positive, the output mode for the mth data is obtained in step S502.

Where the output mode is ‘copy’ in step S503, the output image format is specified as ‘copy’ in step S504. Where the output mode is ‘print’ in step S505, the output image format is specified as ‘print’ in step S506. Where the output mode is ‘FTP transmission’ in step S507, the output image format is specified as ‘scanner’ in step S508.

In the operations of steps S503-S507, where the output mode is ‘copy’, ‘print’ or ‘FFP transmission’, operations appropriate for the output mode are performed by the MFP, but the image data that constitutes the target for processing is not recorded on the file server 200 because it is deemed unnecessary to save the image data on the file server 200 because, in the case of data transmission/receipt within the LAN or simple copying by the MFP, the image data is not sent externally (outside the company, for example).

Where the output mode is determined to be ‘facsimile transmission’ in step S509, or ‘PC facsimile transmission’ in step S510, the output image format is specified as ‘facsimile transmission’ in step S512, and the CPU 101 proceeds to step S518.

Where the output mode is determined to be ‘Internet facsimile transmission’ in step S513 or ‘PC Internet facsimile transmission’ in step S514, the output image format is specified as ‘Internet facsimile transmission’ in step S515, and the CPU 101 proceeds to step S518.

Where the output mode is determined to be ‘Internet printing’ in step S516, the output image format is specified as ‘Internet printing’ in step S517, and the CPU 101 proceeds to step S518.

In step S518, transmission recipient determination is carried out. This is an operation in which the recipients for the image data are determined, i.e., an operation in which it is determined whether or not the image data should be recorded on the file server 200.

Where the determination is negative in step S516 or where the transmission recipient determination operation of step S518 is completed, it is determined in step S519 whether the condition (m)<N is met. If this determination is positive, the CPU 101 increases the value of (m) by 1 in step S520 and returns to step S502.

If the determination is negative in step S519, the CPU 101 returns to the main routine.

Where the image data output mode is specified as ‘facsimile transmission’, ‘PC facsimile transmission’, ‘Internet facsimile transmission’, ‘PC Internet facsimile transmission’ or ‘Internet printing’ in steps S509-S518, the image data is saved on the file server 200 depending on the transmission recipients. Therefore, when image data is sent outside the LAN, the image data can be recorded on the file server 200, enabling management of the image transmission.

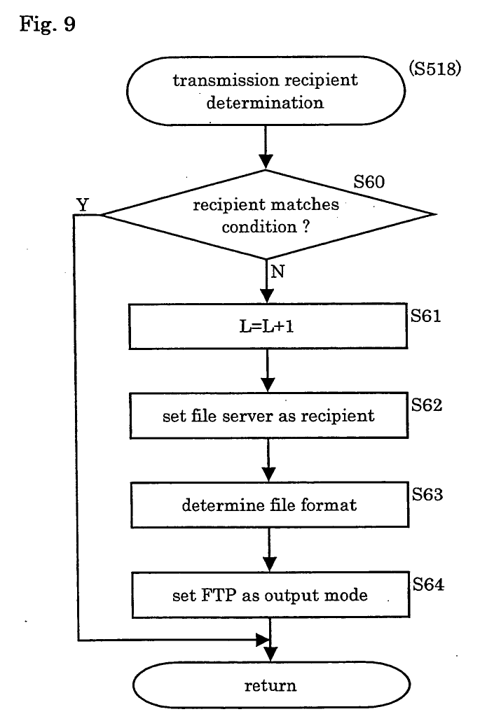

FIG. 9 is a flow chart showing the transmission recipient determination operation (step S518) shown in FIG. 8.

With reference to the drawing, it is determined in step S60 whether the recipients for the image data transmission match the registered conditions. This operation determines whether or not each recipient falls within a predetermined transmission range. Specifically, transmission to recipients that are determined to be included in a specified range via checking of the e-mail address domain, a specific digit of the IP address or the workgroup is deemed transmission within the LAN, and the image data is not recorded on the file server 200 in this case. In other words, if the determination is positive in step S60, the image data is not recorded on the file server 200, and the CPU 101 returns to the main routine without further processing. On the other hand, where the determination is negative in step S60, the operations including and after step S61 are performed in order to record the image data on the file server 200.

In step S61, the value of L is increased by 1 in order to add a job that sends the image data to the file server 200. In step S62, the recipient for the additional job is set in the file server 200. In step S63, an operation to determine the file format for the image data to be sent to the file server 200 is performed. This file format determination operation is described below.

In step S64, ‘FTP transmission’ is specified for the output mode for the job, and the CPU 101 returns to the main routine.

The file format determination operation executed in step S63 is described below. Such determination may be made automatically based on predetermined conditions, or may be based on user selection.

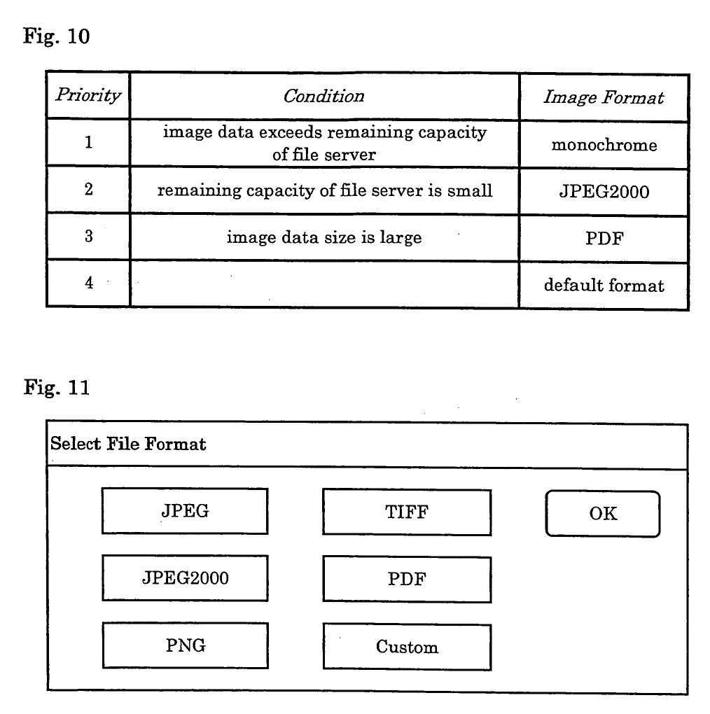

FIG. 10 is a drawing showing the routine executed during the automatic file format determination carried out in step S63 shown in FIG. 9. With reference to the drawing, priority levels 1-4 are assigned for the file format determination. The priority level ‘1’ is chosen first, and if the condition for this level is not met, the file format for the next priority level is chosen.

Specifically, when the priority level ‘1’ is chosen, the remaining capacity of the hard disk drive of the file server 200 is checked, and if the image data to be saved exceeds the remaining capacity of the file server, monochrome is chosen as the image format. Where the condition for priority level ‘1’ is not met, priority level ‘2’ is chosen, and it is determined whether the remaining capacity of the hard disk of the file server 200 is small. If the determination is positive, JPG2000 is selected as the image format.

Where the condition for priority level ‘2’ is not met, priority level ‘3’ is chosen, and it is determined whether the data size of the image data is large. If the determination is positive, PDF is selected as the image format.

Where the condition for priority level ‘3’ is not met, priority level ‘4’ is chosen, and a default file format is selected based on the specified parameter values.

FIG. 11 is a drawing showing a screen displayed when the user manually selects a file format in step S63 shown in FIG. 9. With reference to the drawing, the screen shown in FIG. 11 is displayed on the display unit 107 of the MFP 100, urging the user to specify the file format for the file to be saved on the file server. In this operation, selection can be made from among ‘JPEG’, ‘JPEG2000’, ‘PNG’, ‘TIFF’, ‘PDF’ or ‘Custom’.

When the user is allowed to specify the file format for the file to be recorded on the file server in this way, the user can save the file using a desired format, which offers increased convenience.

The screen shown in FIG. 11 may be displayed on the MFP, the user personal computer or the file server.

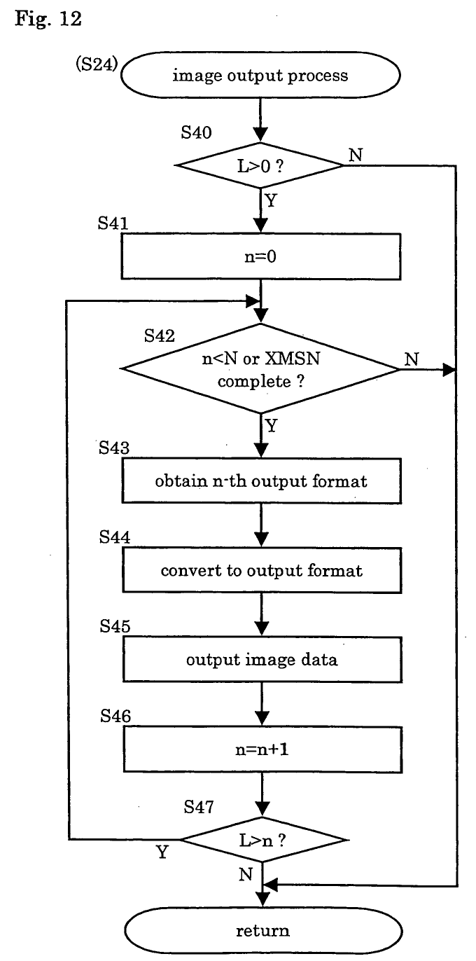

FIG. 12 is a flow chart showing the routine executed during the image output operation (step S24) shown in FIG. 5.

With reference to the drawing, it is determined in step S40 whether the condition (the number of output commands) L>0 is met. If the determination is negative, the CPU 101 returns to the main routine, and if it is positive, ‘0’ is substituted for the variable (n) in step S41.

It is determined in step S42 whether n=N is met or the receipt of the sent image data has been confirmed, and if this determination is positive, the output condition for the nth data set is obtained in step S43.

Based on the output condition obtained in step S44, the image data is converted and output to the recipient specified in association with the output mode obtained in step S45.

The variable (n) is increased by 1 in step S46, and it is determined in step S47 whether the relationship (the number of output commands) L>(n) is met. If this determination is positive, the CPU 101 returns to step S42, and if it is negative, the CPU 101 returns to the main routine.

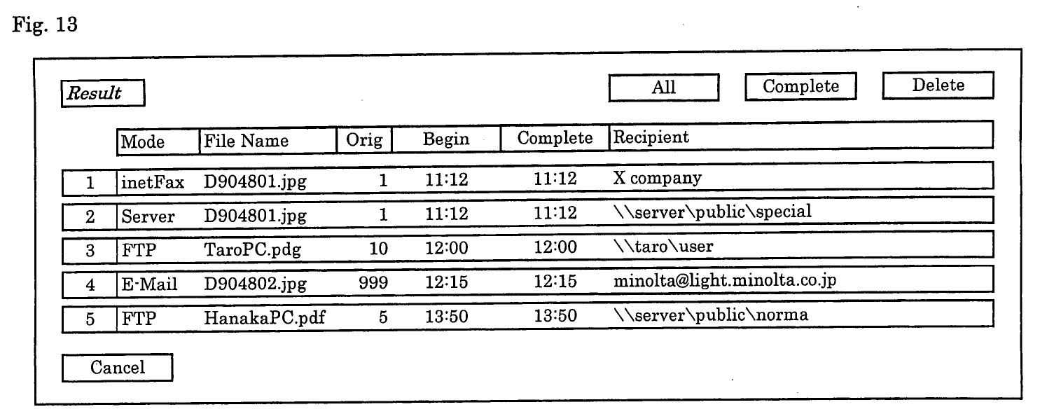

FIG. 13 is a drawing showing a specific example of the transmission history display screen displayed on the display unit 107 of the MFP 100.

With reference to the drawing, displayed in the transmission history display screen are, beginning with the most recently sent image data, the method of transmission, the file name, the number of pages of the original document, the time of registration, the time transmission ended and the recipient.

For example, the transmission indicated by number ‘1’ in FIG. 13 is an inet Fax (Internet facsimile) transmission made to an external company A outside the LAN. As a result, a job indicated by the number ‘2’ is automatically generated via the routine shown in FIG. 9, and transmission is made to the file server 200. The file name for the image data sent to the file server 200 is automatically derived from the document number (i.e., the file name) sent via Internet facsimile transmission and thereafter assigned.

The FTP transmissions indicated by the numbers ‘3’ and ‘5’ were made directly from a user personal computer within the LAN to another user personal computer also within the LAN, and a job by which to record the image data on the file server 200 was not generated. Retained under ‘recipient’ for the transmissions ‘3’ and ‘5’ is the link information to the image data recipients.

By selecting the display of ‘recipient’ from the transmission history display screen shown in FIG. 13, the user can obtain the image sent to the recipient for display or for confirmation. In other words, as shown in FIG. 13, when the location at which the image data is saved is recorded as link information under ‘recipient’, the user can directly check such location from the transmission history display screen, which offers increased convenience.

The transmission history display screen shown in FIG. 13 may be displayed on the file server or on the user personal computer.

The file name for the data saved on the file server may be the same as or different from the file name for the sent original image data. The file name may be either automatically generated in association with the document number assigned to the sent document or manually input by the user.

In addition to the image data itself, such other data as the recipient information and the transmission result may be added thereto, and the image data and the additional information may be saved together in the file server.

Moreover, if saving on the file server is effected only after confirmation of the receipt of the sent image data, such that the image data is saved on the file server when receipt is completed in step S42 of FIG. 12, image data that was not successfully sent can be prevented from being recorded on the file server, which offers increased ease of use. Saving on the file server may be effected only when it is confirmed as a result of verification of the receipt of the transmission that the transmission has ended normally.

In the embodiment described above, the format of the file to be recorded on the file server can be freely changed as shown in FIGS. 10 and 11, but such recording may be made using a single predetermined format.

In addition, it was determined in step S60 of FIG. 9 whether or not the recipient met the registered condition, and the image data was recorded on the file server only when the above determination was negative, but it is also acceptable if the determination in step S60 is omitted, and all image data is recorded on the file server in step S518. In the above embodiment, the image data is recorded on the file server only when it is sent outside the LAN, but it is also acceptable if the image data is recorded on the file server when a predetermined output mode (such as the FTP transmission, for example) is used even for image data transmission within the LAN where necessary.

The operations performed by the above embodiment may be executed via a software program or using a hardware circuit.

A program that executes the operations shown in the flow charts in connection with the above embodiment may be provided, or such program may be provided to the user in the form of a CD-ROM, flexible disk, hard disk, ROM, RAM or memory card on which it is recorded. The program may also be downloaded to the apparatus via a communication line such as the Internet.

An MFP was used as a specific example of the data transmission apparatus in the above embodiment, but any other apparatus may be used in place of the MFP so long as it has a data transmission function.

The embodiment disclosed herein is exemplary in all aspects and is not restrictive in any aspect. The scope of the present invention is indicated not by the description provided above but by the claims, and it should be understood that meanings equivalent to the claims and all changes and modifications within the scope of the claims are included herein.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

1-20. (canceled)

21. A data processing apparatus connected to a network and capable of communication outside of the network, comprising:
a first controller which specifies an output mode for image data to be processed, wherein a first output mode is a mode in which the data processing apparatus sends the image data outside of the network; and
a second controller which, prior to the image data being stored in an archive memory, determines whether the image data is to be stored in the memory based on whether the output mode specified by the first controller is the first output mode.

22. A data processing apparatus as claimed in claim 21, wherein the second controller determines that the image data is to be stored in the memory when the first controller specifies that the output mode is the first output mode.

23. A data processing apparatus as claimed in claim 22, wherein the first output mode is a facsimile transmission mode or an Internet facsimile transmission mode.

24. A data processing apparatus as claimed in claim 21, wherein the first controller further specifies a transmission recipient for the image data, and the second controller determines whether the image data is to be stored in the memory or not based on both the output mode and the transmission recipient specified by the first controller.

25. A data processing apparatus as claimed in claim 21, wherein the memory is an external file server which is connected to the data processing apparatus.

26. A data processing apparatus as claimed in claim 21, wherein when a determination is made that the image data is to be stored in the memory, the second controller further determines a file format for the image data to be stored in the memory.

27. A data processing apparatus as claimed in claim 26, wherein the second controller determines the file format based on a condition of the memory.

28. A data processing apparatus as claimed in claim 26, wherein the file format is manually set by an operator.

29. A data processing apparatus as claimed in claim 21, wherein the image data is stored in the memory after the image data is output.

30. A data processing apparatus connected to a network and capable of communication outside of the network, comprising:
a first controller which specifies a transmission recipient for image data to be processed; and
a second controller which, prior to the image data being stored in an archive memory, determines whether the image data is to be stored in the memory or not based on whether the transmission recipient specified by the first controller is outside of the network.

31. A data processing apparatus as claimed in claim 30, wherein the second controller determines that image data is to be stored in the memory when the first controller specifies that the transmission recipient does not fall within a predetermined transmission range.

32. A data processing apparatus as claimed in claim 31, wherein the predetermined transmission range equals a range within a local area network.

33. A data processing apparatus as claimed in claim 30, wherein the memory is an external file server which is connected to the data processing apparatus.

34. A data processing apparatus as claimed in claim 30, wherein when a determination is made that the image data is to be stored in the memory, the second controller further determines a file format for the image data to be stored in the memory.

35. A data processing apparatus as claimed in claim 30, wherein the image data is stored in the memory after the image data is output.
